(19) United States
(12) Patent Application Publication
(10) Pub. No.: US 2008/0053087 A1
(43) Pub. Date: Mar. 6, 2008

(54) System and Method for Detecting Impaired Operation of an Internal Combustion Engine Turbocharger

(75) Inventors: Kendall Roger Swenson, Erie, PA (US); Kirk Arnaldo Heywood, Erie, PA (US); James Robert Mischler, Girard, PA (US); Ajith Kumar, Erie, PA (US)

Correspondence Address: Dickinson Wright PLLC, 38525 Woodward Avenue, Suite 2000, Bloomfield Hills, MI, 48304, US

(73) Assignee: GENERAL ELECTRIC COMPANY, Schenectady, NY (US)

(21) Appl. No.: 11/468,420

(22) Filed: Aug. 30, 2006

(51) Int. Cl. F02B 29/04; F02B 33/44

(52) U.S. Cl. 60/599; 60/605.1

(57) ABSTRACT

A method and system for detecting impairment of a turbocharger installed as part of an internal combustion engine includes turbo speed monitoring for determining a rotational speed of a turbocharger and airflow sensing for determining airflow rate through the engine. A controller compares the sensed rotational speed of the turbo with a turbo speed threshold and compares the sensed airflow rate with an airflow threshold. A turbocharger impairment flag is set in the event that both the sensed speed of the turbo is less than the turbo speed threshold and the sensed airflow is less than the airflow threshold.

### FIELD OF THE INVENTION

The field of the invention relates to a method and system for early detection of impaired operation of a turbocharger, so as to permit orderly shutdown of an engine without catastrophic damage to the engine's basic mechanical componentry.

### BACKGROUND OF THE INVENTION

Many types of internal combustion engines are equipped with turbochargers (the terms “turbo or “turbocharger” are used interchangeably). Such turbochargers use exhaust energy flowing past an exhaust turbine to rotate a compressor which compresses ambient air. An advantage of a turbocharger is that it is, in essence, a form of power adder because it increases the energy density of an engine by increasing its volumetric efficiency. Turbochargers, like most rotating machinery, need lubrication. Lubrication is usually provided by a pressure feed originating with an engine oil pump used to lubricate the various bearings and other parts needing lubrication within an engine. Unfortunately, in the event that seals or other parts fail within the turbocharger, it is possible for lubricating oil to leak into the inlet air path. This may create a problem, particularly with diesel engines which, as discussed below, operate quite well on lubricating oil.

Operation of a diesel engine on lubricating oil presents a problem inasmuch as fugitive lubricating oil, such as oil flowing through an engine's air inlet system from a damaged turbocharger, may cause the engine to become over-fueled. Because diesel engines use fuel to control the torque output of the engine, it is then possible for the engine to run-away, or in other words, overspeed to the point of severe damage, if it is in an over-fueled condition. The problem of diesel engines running away or over-speeding destructively is known. U.S. Pat. Nos. 6,429,540 and 6,552,439, which are assigned to the assignee of the present invention, disclose methods for stopping a run-away engine.

### BRIEF DESCRIPTION OF THE INVENTION

The '540 and '439 patents do not deal with detection of an operationally impaired turbocharger. The present invention is, however, directed toward a solution which deals with preventing run-away of an engine by early detection of turbocharger impairment, followed by remedial action.

According to an aspect of the present invention, a system for detecting impairment of a turbocharger installed as part of an internal combustion engine includes a turbo speed sensor for determining the rotational speed of a turbocharger, and an airflow sensing sub-system for determining airflow rate through the engine. A controller, which is operatively connected with the turbo speed sensor and the airflow sensing sub-system, compares the sensed rotational speed of the turbo with a turbo speed threshold and further compares the sensed airflow rate with an airflow threshold. The controller sets a turbocharger impairment flag in the event that both the sensed speed of the turbocharger is less than turbo speed threshold and the sensed airflow rate is less than the airflow threshold. The airflow sensing sub-system preferably includes either a mass airflow sensor or an intake manifold pressure sensor, either alone, or in combination with an engine speed sensor, with the controller using outputs from the intake manifold pressure sensor and the engine speed sensor to determine the sensed airflow rate to the engine.

An engine according to another aspect of the present invention further includes an emergency shutdown system operated by the controller for stopping the engine in the event that the turbocharger impairment flag is set. The emergency shutdown system may include a fuel cutoff command to the fuel system for providing fuel to the engine's cylinders.

According to yet another aspect of the present invention, a method for detecting and responding to turbocharger impairment in an internal combustion engine includes determining the rotational speed of a turbocharger and determining the airflow rate through an engine equipped with the turbocharger. The method also includes comparing the determined rotational speed of the turbocharger with a turbo speed threshold, and further comparing the determined airflow rate with an airflow threshold. In the event that both the sensed speed of the turbocharger is less than the turbo speed threshold and the sensed airflow is less than the airflow threshold, fuel may be shut off to the engine.

According to another aspect of the present invention, the airflow rate through the engine may be determined by comparing ambient air pressure with air pressure within the engine's intake manifold at a location downstream from the turbocharger. In the event that the intake manifold pressure is less than the ambient air pressure, it may be concluded that turbocharger has become impaired if the turbocharger speed has declined below the threshold value. If the engine does not stop following cutoff of fuel, it may be stopped by closing an air shutter in the intake manifold, or by introducing an inert gas into the engine.

In another aspect of the present invention, a method for detecting and responding to turbocharger impairment in an internal combustion engine includes monitoring the value of a parameter corresponding to requested engine output, such as commanded crankshaft output torque, and monitoring air pressure within the engine's intake manifold, downstream of the turbocharger. In the event that the air pressure within the intake manifold decreases without a corresponding change in the value of the parameter corresponding to requested engine output, a turbocharger impairment flag will be set.

It is an advantage of a method and system according to the present invention that turbocharger impairment may be detected before the engine runs away, or enters another type of abnormal operating regime occasioned by ingestion of lubricating oil from a failed turbo. This is possible because the present method and system advantageously utilize the storage capacity within the engine's intercooler to store fugitive oil from the turbocharger, thereby giving a window of time within which to stop the engine before runaway occurs.

It is a further advantage of a method and system according to the present invention that extremely high costs associated with engine runaway may be avoided, particularly in remotely controlled applications such as those encountered with unmanned railroad locomotives employed at multiple locations within long trains. The present invention is also useful for engines used in stationary power generation, marine, and automotive applications.

Other advantages, as well as features of the present invention, will become apparent to the reader of this specification.

### BRIEF DESCRIPTION OF THE DRAWINGS

FIG. 1 is a schematic representation of an engine according to an aspect of the present invention.

FIG. 2 is a block diagram of an engine including a control system according to an aspect of the present invention.

FIG. 3 is a flow diagram of a method for detecting turbocharger impairment according to an aspect of the present invention.

### DETAILED DESCRIPTION OF THE INVENTION

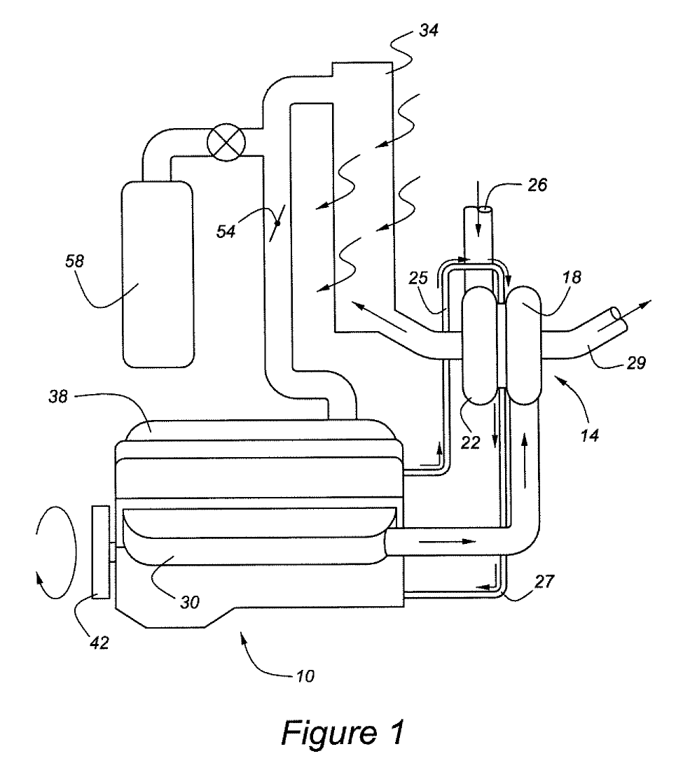

As shown in FIG. 1, engine 10 is equipped with a turbocharger system including air-to-air charge air intercooling. Those skilled in the art will appreciate in view of this disclosure, however, that other types of intercoolers, such as air-to-liquid intercoolers, could be employed with a system and method according to the present invention. Moreover, the present system and method could be employed without an intercooler being interposed between the turbocharger and the air intake manifold.

Engine 10 has turbocharger 14 including exhaust turbine 18 and compressor section 22. Exhaust flows from exhaust manifold 30 and through exhaust turbine 18, before exiting the engine via exhaust pipe 29. Combustion air enters through air inlet 26, and after passing through compressor section 22, the charge air flows through intercooler 34, wherein heat is extracted from the air. Turbocharger 14 has a center bearing (not shown) which is supplied with engine lubricating oil under pressure from the engine's lubrication system, by supply line 25. Oil returns to engine 10 from turbo 14 via return line 27. In the event that turbocharger 14 fails, oil originating from line 25 may be drawn into intake manifold 38.

Air leaving intercooler 34 passes into intake manifold 38 after flowing past air shutter 54, which is an emergency shutdown device. It is also noted that inert gas source 58 is coupled to intake manifold 38 as yet another type of emergency shutdown device.

In conventional fashion, engine 10 has a rotating crankshaft, 42, for extracting power from engine 10.

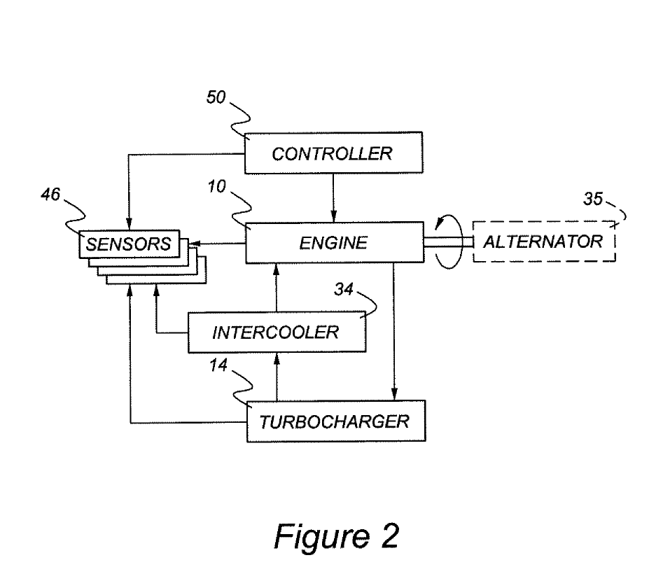

FIG. 2 illustrates controller 50, which is operatively connected with engine 10 as well as with a plurality of sensors, 46. These sensors include a turbo speed sensor for determining rotational speed of turbocharger 14, and other sensors such as an engine crankshaft speed sensor, ambient air pressure sensor, an intake air pressure sensor for determining the pressure within intake manifold 38, and other sensors known to those skilled in the art of engine control and suggested by this disclosure. FIG. 2 shows that engine 10 may be coupled to an alternator, 35. Alternator 35 is exemplary of a class of loads, including mechanical, electromechanical, hydraulic, and other loads. The load coupled to engine 10 may be used to decelerate engine 10 during an emergency shutdown sequence.

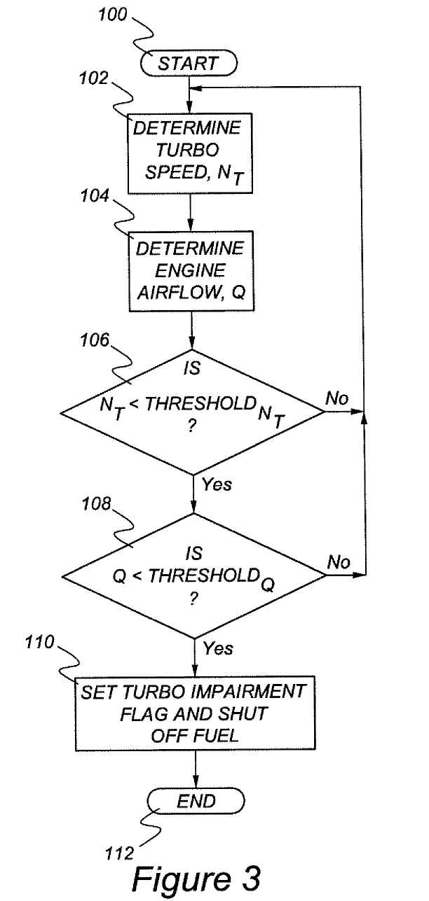

FIG. 3 illustrates a method for detecting operational impairment of a turbocharger according to the present invention, wherein controller 50 starts at block 100 and then at block 102 determines turbo speed, N_{T}. After determining turbo speed at block 102, controller 50 moves to block 104 wherein the engine airflow, Q, is determined. Then, at block 106, controller 50 compares the sensed or determined turbo speed N_{T} with a turbo speed threshold. The turbo speed threshold could be based on either current or historical operating conditions, including, for example, horsepower output, ambient and intake manifold air pressure, exhaust pressure, and engine speed. In general, the analytical routine of FIG. 3 is intended to determine whether turbo 14 is performing work on the engine's incoming air supply. Stated another way, the turbo speed threshold may be selected based upon the power available to exhaust turbine 18.

If the turbo speed is greater than a threshold value, so that the answer of the question posed at block 106 is “no,” the routine returns to block 102 and keeps running. If, however, the answer to the question posed at block 106 is “yes,” in other words, the turbo speed is less than the threshold value, controller 50 moves to 108 wherein the value of the determined engine airflow, Q, is compared with the threshold value for Q, which may be based upon either current or past operating conditions of engine 10. If Q is greater than the threshold value, the routine will once again return to block 102. If, however, the answer is “yes” at block 108, and in other words, Q is less than the threshold value, controller 50 moves to block 110 wherein a turbocharger impairment flag is set. The threshold values for turbo speed and engine airflow may be drawn from lookup tables or calculated by controller 50 based upon a number of engine operating parameters such as engine speed, engine load, fuel rate, and other parameters.

As shown in FIG. 3 fuel may be shut off at block 1 10. This shut off is, however, optional. The turbocharger impairment flag may be used to trigger an alert to the engine's human operator, who may then decide to shut the fuel off. In any event, the routine ends at block 112. As used herein, the term “turbocharger impairment flag” refers to a decision point at which controller 50 has concluded that turbo 14 has become operationally impaired. Such decision need not be marked by a specific flag; what is important is that the routine acknowledge the impairment. Those skilled in the art will appreciate in view of this disclosure that a conclusion of turbo impairment may be memorialized in several different ways according to the present invention.

If engine 10 does not shut off after block 110 when the fuel is shut off, emergency shutdown system may be employed. This may, as previously described, include the closing of air shutter 54, or the introduction of inert gas from inert gas system 58. The emergency shutdown may also include the loading of engine 10 with either alternator 35, or with another load source in the event that the shut off of fuel is not effective in stopping the engine. These three forms of emergency shutdown, as well as others known to those skilled in the art and suggested by this disclosure, may be employed serially or simultaneously.

Returning to FIG. 3, the determination of engine airflow at block 104 may be accomplished in a variety of ways. For example, one of sensors 46 may be a mass airflow sensor located within intake manifold 38. Alternatively, the airflow sensing sub-system may include an ambient air pressure sensor and an intake manifold pressure sensor, with readings from both sensors being compared by controller 50. In this case, a reading of sub-atmospheric pressure within intake manifold 38 is a clear indication that turbocharger impairment may have occurred. As yet another alternative, the airflow sensing sub-system may include an intake manifold pressure sensor and an engine speed sensor with a controller 50 using the outputs from the intake manifold pressure sensor and speed sensor to determine a sensed airflow rate.

Detection and response to turbocharger impairment may be embodied as a monitoring process wherein the value of a parameter corresponding to requested engine output, such as commanded crankshaft output torque, is monitored, as well as air pressure within the intake manifold downstream of the turbocharger. In the event that the air pressure within the intake manifold decreases without a corresponding change in the value of commanded crankshaft output torque, the turbocharger impairment flag will be set. This may be followed by engine fueling shutdown and other emergency stopping procedures.

In a more universal sense, a turbo impairment detection technique according to an embodiment of the present invention involves monitoring the turbo's power output, with the method of FIG. 3 being but one example for accomplishing this purpose. Turbo power output may be determined by measuring turbo speed and shaft torque, or turbo speed and turbo pressure ratio, or pressure ratio and mass airflow rate. The turbo power output is compared with the exhaust energy available to exhaust turbine 18. The available exhaust energy and its derivative, the energy available to exhaust turbine 18, may be determined with reference to such engine operating parameters as engine speed, engine load, various operating temperatures, engine fuel rate, and yet other operating parameters known to those skilled in the art and suggested by this disclosure. In the event that the turbo's power output is less than the amount predicted by controller 50, based upon either the recited operating parameters or their surrogates, the turbo impairment flag may be set.

While particular embodiments of the invention have been shown and described, numerous variations and alternate embodiments will occur to those skilled in the art. Accordingly, it is intended that the invention be limited only in terms of the appended claims.

1. A system for detecting operational impairment of a turbocharger installed as part of an internal combustion engine, comprising:
a turbo speed sensor for determining the rotational speed of a turbocharger;
an airflow sensing subsystem for determining the airflow rate through an engine equipped with the turbocharger; and
a controller, operatively connected with said turbo speed sensor and said airflow sensing subsystem, with said controller comparing the sensed rotational speed of the turbocharger with a turbo speed threshold, and further comparing the sensed airflow rate with an airflow threshold, and with said controller setting a turbocharger impairment flag in the event that both the sensed speed of the turbocharger is less than said turbo speed threshold and the sensed airflow is less than said airflow threshold.

2. The system of claim 1, wherein said airflow sensing subsystem comprises a mass airflow sensor.

3. The system of claim 1, wherein said airflow sensing subsystem comprises an ambient air pressure sensor, an intake manifold pressure sensor, and a comparator, operatively connected with said controller and with each of said pressure sensors, for comparing the output of said ambient air pressure sensor with the output of the intake manifold pressure sensor, with said controller setting said turbocharger impairment flag in the event that both the sensed speed of the turbocharger is less than said turbo speed threshold and the sensed intake manifold pressure is less than the sensed ambient air pressure.

4. The system of claim 1, wherein said airflow sensing subsystem comprises an intake manifold pressure sensor and an engine speed sensor, with said controller using outputs from said intake manifold pressure sensor and said engine speed sensor to determine the sensed airflow rate through the engine.

5. A reciprocating internal combustion engine, comprising:
a reciprocating engine;
a turbocharger for providing air at a superatmospheric pressure to an intake manifold of said engine;
an intercooler located between said turbocharger and said intake manifold;
a turbo speed sensor for determining the rotational speed of said turbocharger;
an airflow sensing subsystem for determining the airflow rate through said engine; and
a controller, operatively connected with said turbo speed sensor and said airflow sensing subsystem, with said controller comparing the sensed rotational speed of the turbocharger with a turbo speed threshold, and further comparing the sensed airflow rate with an airflow threshold, and with said controller setting a turbocharger impairment flag in the event that both the sensed speed of the turbocharger is less than said turbo speed threshold and the sensed airflow is less than said airflow threshold.

6. The engine of claim 5, further comprising an intercooler positioned between said turbocharger and said intake manifold.

7. The engine of claim 5, further comprising an emergency shutdown system, operated by said controller, for stopping said engine in the event that said turbocharger impairment flag is set.

8. The engine of claim 7, wherein said emergency shutdown system comprises a fuel cutoff command to a fuel system for providing fuel to the engine's cylinders.

9. The engine of claim 7, wherein said turbo speed threshold and said airflow threshold are determined as functions of at least engine speed.

10. A method for detecting and responding to a turbocharger impairment in an internal combustion engine, comprising:
determining the rotational speed of a turbocharger;
determining the airflow rate through an engine equipped with the turbocharger;
comparing the determined rotational speed of the turbocharger with a turbo speed threshold, and further comparing the determined airflow rate with an airflow threshold; and
in the event that both the sensed speed of the turbocharger is less than said turbo speed threshold and the sensed airflow is less than said airflow threshold, shutting off fuel flowing to the engine.

11. The method of claim 10, wherein the airflow rate through the engine is determined by comparing ambient air pressure with air pressure within an intake manifold located downstream from the turbocharger.

12. The method of claim 10, further comprising shutting off combustion air to the engine in the event that the engine does not stop following cutoff of the fuel.

13. The method of claim 10, further comprising introducing an inert gas into the engine to exclude combustion air in the event that the engine does not stop following cutoff of the fuel.

14. The method of claim 10, further comprising loading the engine with a rotating electrical machine coupled to the engine, so as to stop the engine in the event that the engine does not stop following cutoff of the fuel.

15. The method of claim 10, further comprising capturing fugitive oil from the turbocharger in an intercooler in the event that the turbocharger becomes impaired.

16. A method for detecting and responding to turbocharger impairment in an internal combustion engine, comprising:
monitoring the value of an operating parameter related to turbocharger output; and
in the event that the value of said operating parameter changes without a corresponding change in the engine's power output, setting a turbocharger impairment flag.

17. The method of claim 16, further comprising shutting off fuel flowing to the engine in the event that said turbocharger impairment flag is set.

18. The method of claim 16, wherein said operating parameter relating to turbocharger output comprises turbocharger speed.

19. The method of claim 16, wherein said operating parameter relating to turbocharger output comprises turbocharger pressure ratio.

20. A method for detecting operational impairment of a turbocharger having an exhaust turbine and a charge air compressor installed on a common shaft in an internal combustion engine system, comprising:
determining the power available to the turbocharger's exhaust turbine;
predicting the turbocharger's power output, based at least in part upon the power available to the exhaust turbine;
determining the actual power output of the turbocharger;
comparing th turbocharger's actual power output with the predicted power output; and
in the event that the turbocharger's actual power output is less than the predicted power output, setting a turbo impairment flag.

21. The method of claim 20, wherein the actual power output of the turbocharger is determined by measuring the turbocharger pressure ratio and turbo shaft speed.

22. The method of claim 20, wherein the actual power output of the turbocharger is determined by measuring the turbocharger shaft speed and torque.

23. The method of claim 20, wherein the actual power output of the turbocharger is determined by measuring the turbocharger pressure ratio and charge air mass flow rate.
